(19) United States
(12) Patent Application Publication
(10) Pub. No.: US 2004/0211890 A1
(43) Pub. Date: Oct. 28, 2004

(54) Positional encoder assembly

(75) Inventors: Robert Malcolm Setbacken, Santa Barbara, CA (US); Gary Thomas Rhodes, Goleta, CA (US); Kevin Michael Carbone, Santa Barbara, CA (US); Gregg Richard Service, Goleta, CA (US)

Correspondence Address: BRINKS HOFER GILSON & LIONE, P.O. BOX 10395, CHICAGO, IL, 60610, US

(73) Assignee: Renco Encoders, Inc.

(21) Appl. No.: 10/829,546

(22) Filed: Apr. 22, 2004

Related U.S. Application Data
(60) Provisional application No. 60/465,295, filed on Apr. 25, 2003.

(51) Int. Cl. G01D 5/34

(52) U.S. Cl. 250/231.13; 250/231.14

(57) ABSTRACT

A lead frame assembly that includes a lead frame defining a cavity, a lead frame contact disposed within the cavity and a sensor disposed on the lead frame contact.

Applicants claim, under 35 U.S.C. § 119(e), the benefit of priority of the filing date of Apr. 25, 2003, of U.S. Provisional Patent Application Ser. No. 60/465,295 filed on the aforementioned date, the entire contents of which are incorporated herein by reference.

### BACKGROUND

1. Field of the Invention

The present invention relates to the field of optical measurement devices, and more particularly to the field of optical encoders utilizing precision light emission coupled with light sensing and data processing electronics.

2. Brief Summary of the Related Art

Positional encoder assemblies, and in particular, rotary position encoders that incorporate a sensor affixed to a molded lead frame have heretofore enabled greater efficiencies in precision measurement application. The typical rotary position encoder embodies a printed circuit board (PCB) having a sensor deposited thereon. The sensor is generally coupled to processing circuitry through a series of leads and wires. A group of encapsulating gels are thereafter selected to cover and protect the sensitive electronics of the sensor and the sensor's attending electronic circuitry. In general terms, this manufacturing approach can be described as COB or Chip-On-Board.

Although rotary position encoders utilizing the above mentioned COB principles provided certain benefits, design limitations in the prior art have reduced the overall efficiency, reliability, and durability of the product. Of particular concern is that in affixing the sensor to the PCB, the geometrical sensitivity of the encoder is compromised. For example, the distance between the surface of the encapsulating gel and the PCB is not precisely known. Because of this, the air gap between the code disk and the encapsulated surface on the assembled encoder will not be optimized. As a result, any defect in the manufacture of these types of encoders may therefore affect the operability of the entire system.

These problems are compounded by further difficulties associated with the application of the encapsulants to the sensor and surrounding circuitry. The encapsulants are generally deposited in a liquid form, which may not be controllable during manufacture and may result in misshapen masses of encapsulant that hinder the optical sensitivity of the sensor as well as the fidelity of the electrical connections from the sensor to the circuit board assembly.

Another difficulty encountered in the prior art is that assembly of the encoder is a difficult process, and the geometrical, optical, and electrical difficulties listed above may conspire to render the product useless.

### SUMMARY OF THE INVENTION

Accordingly, one aspect of the present invention is a positional encoder assembly including a light source to generate an optical signal coupled to an optical support structure housing a refractive optic to direct the optical signal. A lead frame defining a cavity is coupled to the optical support structure by having a projection of the optical support structure be received in at least one recess of the lead frame. A sensor is disposed within the cavity to generate an electrical signal in response to the optical signal, wherein the electrical signal is distributed to a circuit board assembly. The lead frame is disposed on the circuit board assembly such that the sensor is disposed at a predetermined elevation with respect to the circuit board assembly.

The above aspect of the present invention provides greater certainty in alignment of the optical components of the encoder assembly.

The above aspect of the present invention also provides improved performance and reliability over the prior art. Particularly, the lead frame having a cavity defined therein provides an exact height of the sensor above the circuit board assembly which is of particular aid in the design of the encoder product. Additionally, the lead frame with an integrated cavity eliminates the need for multiple types of encapsulation, requiring only a minimum amount of encapsulant to cover the sensor and attendant circuitry.

A second aspect of the invention regards a lead frame assembly that includes a lead frame defining a cavity, a lead frame contact disposed within the cavity and a sensor disposed on the lead frame contact.

A third aspect of the present invention regards a positional encoder assembly that includes a light source to generate an optical signal, a circuit board assembly and a lead frame supported upon the circuit board assembly, the lead frame defining a first cavity and a hollow within which the light source is disposed. A connector is positioned on the circuit board assembly and located externally to the lead frame and a connector pad is positioned within a second cavity defined by the lead frame and is electrically connected to the connector. A sensor is disposed within the second cavity and is supported upon a lead frame contact and adapted to generate an electrical signal in response to the optical signal, the electrical signal distributed to a wire bond that is located within the second cavity and is in electrical contact with the connector pad so that the electrical signal is distributed to the connector and the circuit board assembly; wherein the second cavity has a height that is above a maximum height of the wire bond and the connector pad is at least as high above the circuit board assembly as a top surface of the sensor.

The above described second and third aspects of the invention provide the advantage of allowing the amount of encapsulation of a sensor to be minimized.

A fourth aspect of the present invention regards a positional encoder assembly including a light source to generate an optical signal, a circuit board assembly and a lead frame supported upon the circuit board assembly, the lead frame defining a first cavity and a hollow within which the light source is disposed. A connector is positioned on the circuit board assembly and located externally to the lead frame and a connector pad positioned within a second cavity defined by the lead frame and is electrically connected to the connector. A sensor is disposed within the second cavity and is supported upon a contact and adapted to generate an electrical signal in response to the optical signal, the electrical signal distributed to a wire bond that is located within the second cavity and is in electrical contact with the connector pad so that the electrical signal is distributed to the connector and the circuit board assembly; wherein the second cavity lies below the first cavity.

The above fourth aspect of the invention provides the advantage of allowing for thicker materials such as glass to be used for a code disk used with such a position encoder assembly.

These and other advantages of the present invention are more filly described below with reference to a preferred embodiment and the following drawings.

### BRIEF DESCRIPTION OF THE DRAWINGS

FIG. 1 is an exploded view of a positional encoder assembly in accordance with one embodiment of the present invention.

FIG. 2 is a view of an optical support structure to be used with the positional encoder assembly of FIG. 1 in accordance with the present invention.

FIG. 3 is a perspective view of a lead frame assembly to be used with the positional encoder assembly of FIG. 1 in accordance with the present invention.

FIG. 4(a) is a perspective view of the optical support structure of FIG. 2 in the process of being attached to the lead frame assembly of FIG. 3;

FIG. 4(b) is a cross-sectional view of the optical support structure of FIG. 2 attached to the lead frame assembly of FIG. 3 as taken along line 4(b)-4(b) of FIG. 4(a);

FIG. 5 is a partial plan view of the positional encoder assembly in accordance with the present invention.

FIG. 6 is a partial cross-section of the positional encoder assembly of FIG. 1 in accordance with the present invention along section 6-6 of FIG. 5.

FIG. 7 is a partial cross-section of the positional encoder assembly in accordance with the present invention along section 7-7 of FIG. 5.

FIG. 8 is an enlarged view of a portion of FIG. 7.

FIG. 9(a) is an improved view of FIG. 6 in accordance with the present invention.

FIG. 9(b) is an improved and enlarged view of portions of FIG. 9(a) in accordance with the present invention.

FIG. 10 is a second improved view of a portion of FIG. 6 in accordance with the present invention.

FIG. 11 is a top view of a portion of the lead frame assembly of FIG. 3 with an LED hollow superimposed thereon in accordance with the present invention.

FIG. 12 is a cross-sectional view of the lead frame assembly of FIG. 3 taken along line 12-12 of FIG. 3.

FIG. 13 is a cross-sectional view of the lead frame assembly of FIG. 3 taken along line 13-13 of FIG. 12.

### DETAILED DESCRIPTION OF THE PRESENTLY PREFERRED EMBODIMENTS

As shown and described herein, the present invention is an improved positional encoder assembly including in part an optical support structure and a lead frame wherein the lead frame advantageously supports and contains a sensor and its attendant electronics.

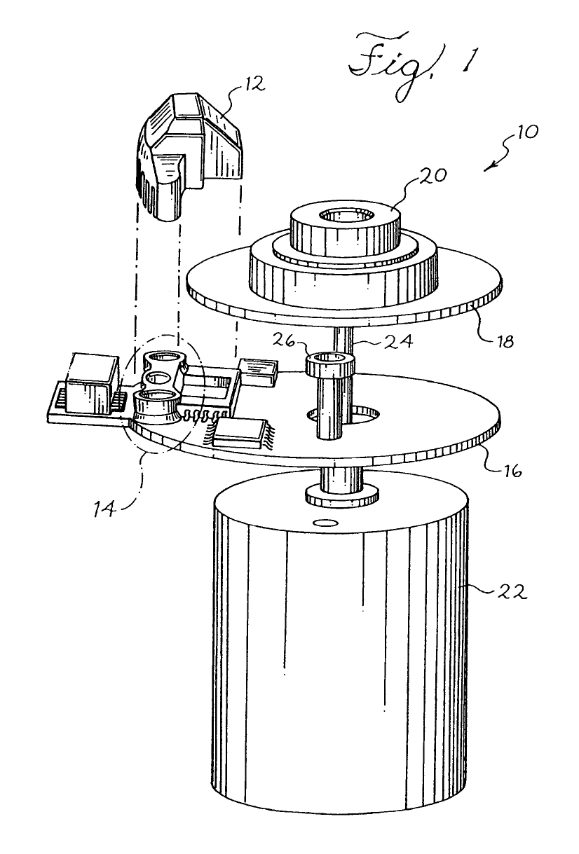

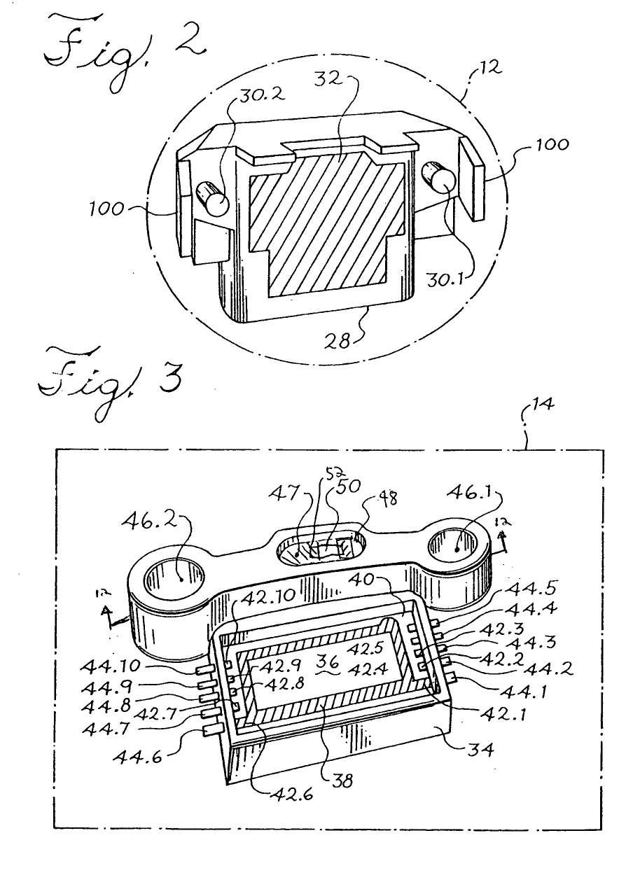

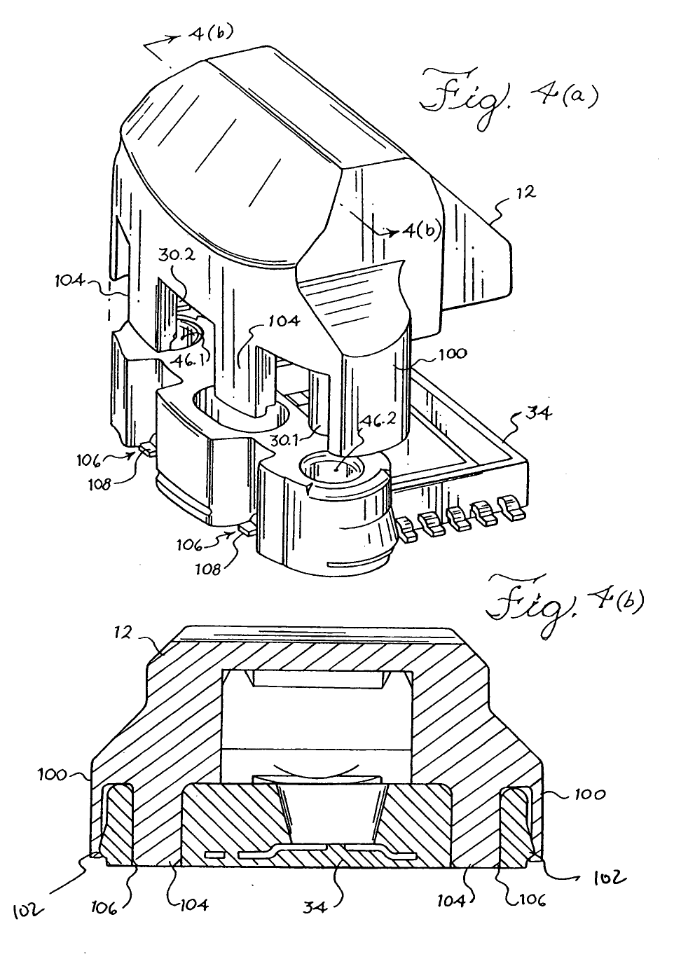

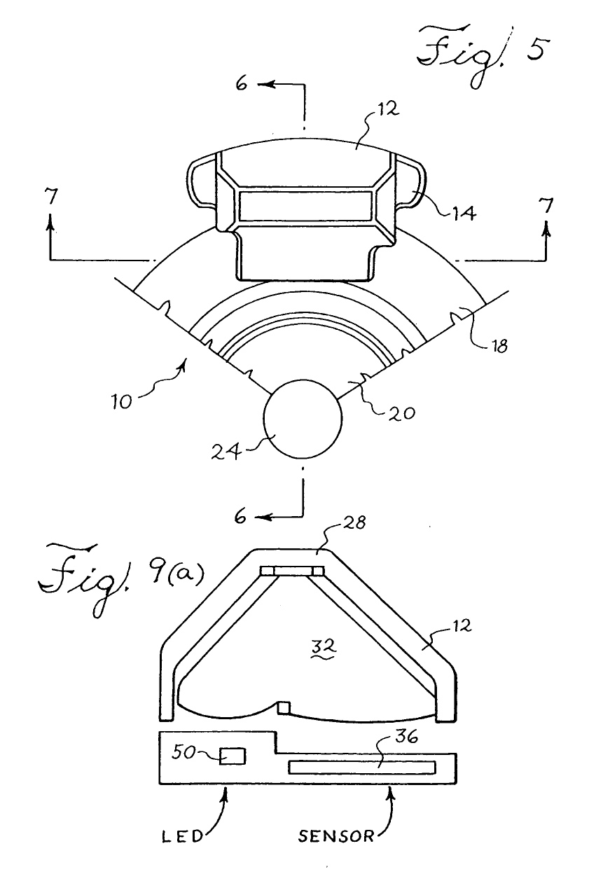

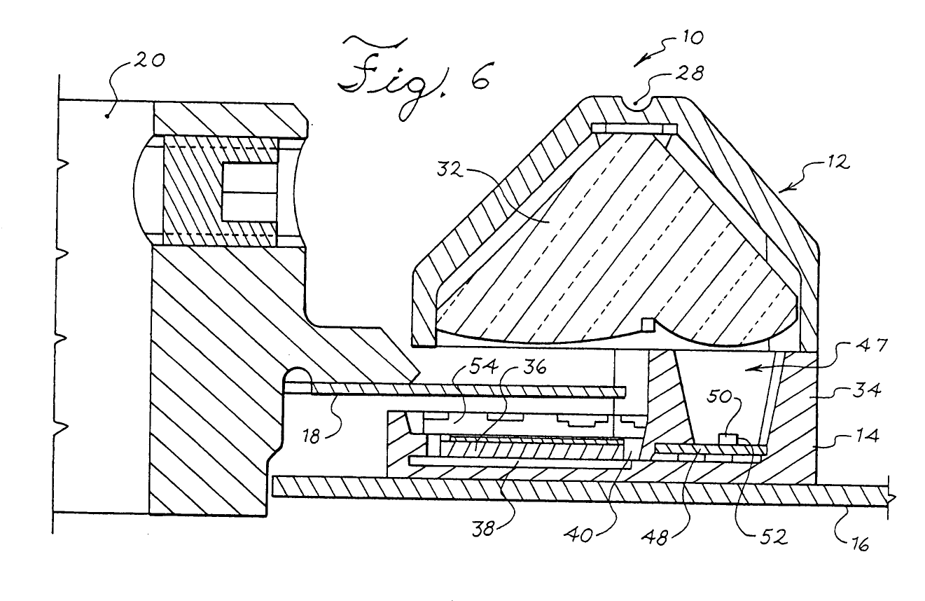

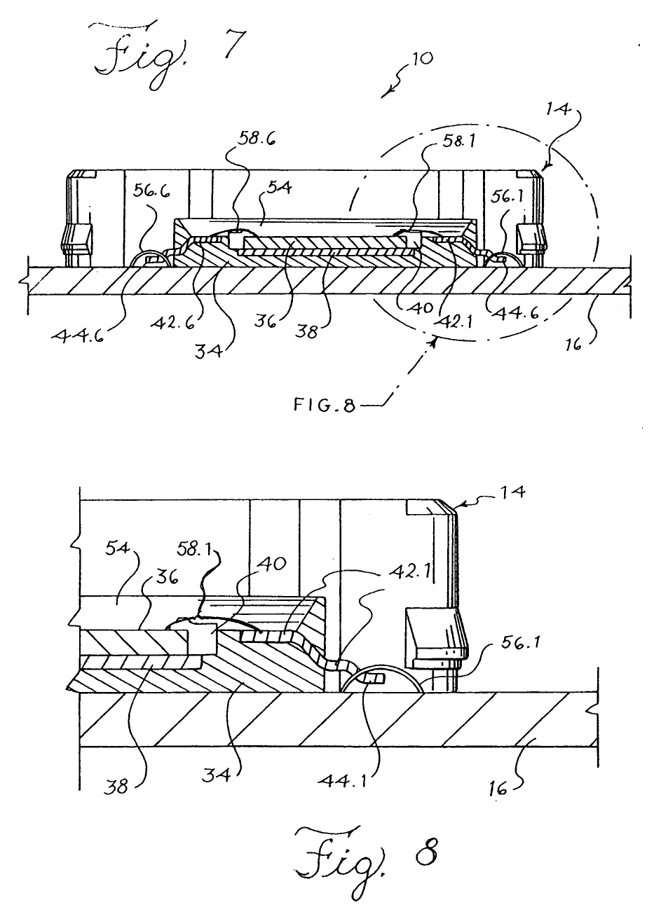

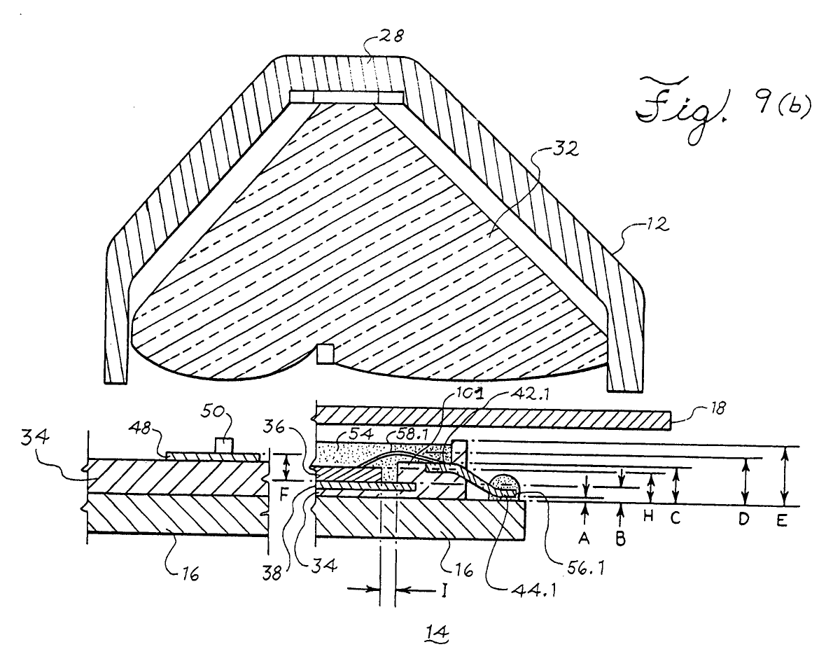

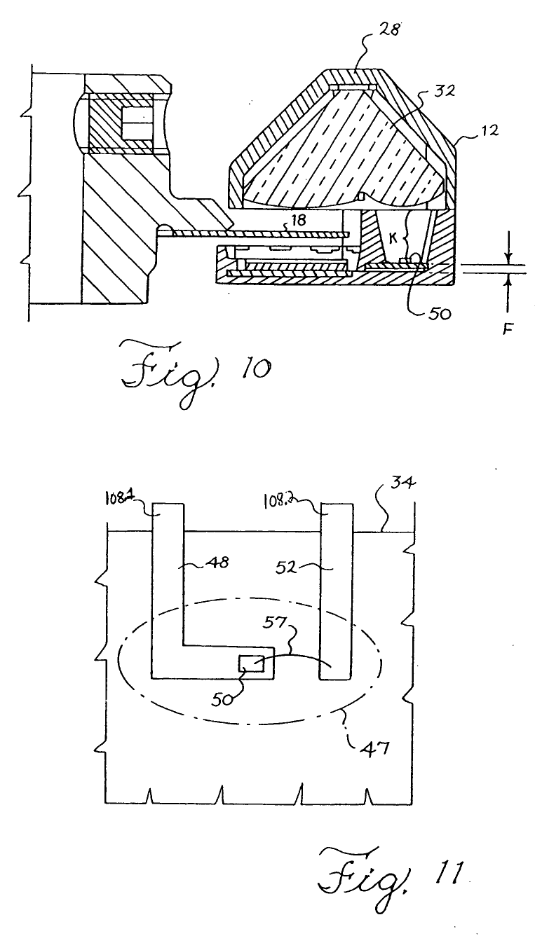

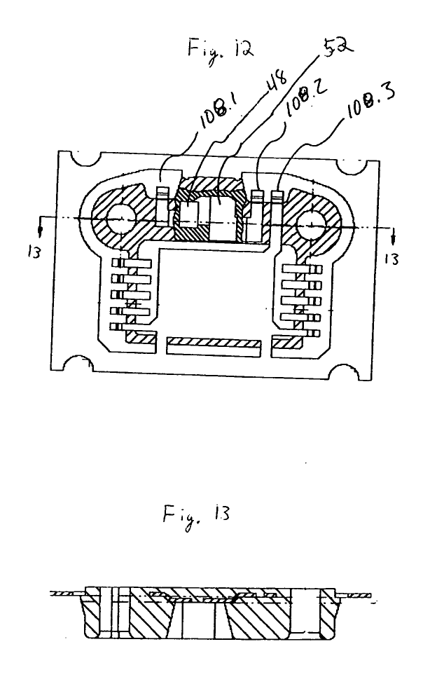

FIG. 1 is an exploded view of a positional encoder assembly 10 in accordance with one embodiment of the present invention. As shown, the positional encoder assembly 10 is a rotational position encoder. However, the present invention as further described herein may be configured as a linear position encoder.

The positional encoder assembly 10 includes generally an optical support structure 12 and a lead frame assembly 14 that are conjoined as discussed below. A circuit board assembly 16 and a code disk 18 are disposed about an axle 24 that is coupled to a motor 22. A hub 20 is disposed above the code disk 18 to control the rotation of the code disk 18 about the axle 24. The circuit board assembly 16 is fastened to the motor 22 by a retaining bolt 26 that is inserted through an opening formed in the circuit board assembly 16 and threadedly engages a threaded opening of the motor 22. Of course other ways of fastening the circuit board assembly 16 to the motor 22, such as glue or the use of snap features.

The optical support structure 12 is shown in more detail in FIG. 2. The optical support structure 12 includes a support structure body 28 having at least one projection 30.1, 30.2. The support structure body 28 encapsulates an optical element 32, preferably a prismatic lens, for the direct refraction of incident light. In a preferred embodiment, the optical support structure 12 includes two projections 30.1, 30.2 for mating with the lead frame assembly 14 as described below.

A perspective view of the lead frame assembly 14 is shown in FIG. 3. The lead frame assembly 14 includes a lead frame 34 defining a cavity 40 for receiving a lead frame contact 38 and a sensor 36. As shown in FIG. 9(b), the lead frame assembly 14 has a stepped profile near its perimeter and has a maximum height E that is approximately 1.4 mm. Thus, the cavity has a stepped shape as well that defines a top opening that is located a distance E above the circuit board assembly 16. As will be explained in detail below, the cavity 40 serves two functions: 1) it fixtures the connection points which allow signals from the sensor 36 to be routed to an end-application and 2) it provides a structure, which facilitates the covering of the wire-bonds and the sensor 36 with an optimized amount of protective transparent encapsulant 54.

In a preferred embodiment, the sensor 36 is an OPTO-ASIC sensor integrating the functions of data sensing, data sensor signal conditioning, commutation sensing, and commutation sensor signal conditioning onto a single silicon substrate. As shown in FIGS. 3 and 9, the sensor 36 is disposed within a lower portion of the cavity 40 and is centered therein so as to be a distance I (approximately 0.5 to 1.0 mm) from the side interior wall of the cylindrical portion. The distance I can be made arbitrarily small by having the lower, cylindrical portion of the cavity 40 placed closer to the sensor 36. This distance is limited by mechanical tolerances of the sensor and cavity fabrication processes, as well as the placement accuracy of the assembly equipment. Reducing the distance I aids in reducing the amount of encapsulation material used and increases resistance to thermal stresses which could lead to delamination of the encapsulant.

A portion of the sensor 36 is adjacent to a set of external connector pads 42.1-42.10 that are coupled to a set of external connectors 44.1-44-10. As shown in FIG. 9(b), the tops of the connector pads 42.1-42.10 are level with an inner portion 101 of the level frame 34 and are positioned a distance C (approximately 1 mm) above the circuit board assembly 16. In the shown embodiment, there are ten external connectors 44.1-44.10. However, it is understood that in alternate embodiments the exact number of external connector pads 42.1-42.10 and external connectors 44.1-44.10 will depend on the amount of data received and processed by the sensor 36.

As shown in FIGS. 3 and 4(a), the lead frame 34 further includes recesses 46.1, 46.2 for receiving the projections 30.1, 30.2 of the optical support structure 12 described above. As cylindrical projections 30.1, 30.2 are inserted into recesses 46.1, 46.2, two side projections 100 slide over the sides of the lead frame 34 and engage ridges 102 in a snap fit manner. Once the optical support structure 12 engages the lead frame 34, the two rear flanges 104 of the optical support structure 12 are positioned within slots 106 formed in the lead frame 34 so as to provide additional lateral stiffness to the assembly and protection for the external connectors from inadvertent contact with foreign objects. It is understood that other attachments are possible, such as press-fits, glues, screws, snap fits.

As shown in FIG. 3, a light emitting diode (LED) hollow 47 is disposed between the recesses 46.1, 46.2 and adjacent to the cavity 40. Disposed within the LED hollow 47 are an LED contact 48 and an LED 50 as shown in FIG. 12. Note that the LED 50 may be an n-type or a p-type LED.

FIG. 5 is a partial plan view of the positional encoder assembly 10 in accordance with the present invention. The optical support structure 12 is connected to the lead frame assembly 14 by using projections 30.1, 30.2 (FIGS. 2 and 4(a)-(b)) as alignment guides by aligning them with recesses 46.1, 46.2 (FIGS. 3 and 4(a)) and inserting the projections within the recesses. During insertion, the side projections 100 engage the ridges 102 in a snap fit manner as described previously. The code disk 18 is disposed beneath the hub 20 such that during operation, the code disk 18 is rotatable about the axis 24.

FIG. 6 is a partial cross-section of the positional encoder assembly 10 taken along section 6-6 of FIG. 5. As previously described, the optical support structure 12 is connected to the lead frame assembly 14, which is disposed directly on the circuit board assembly 16. The code disk 18, disposed beneath the hub 20, is inserted between the optical support structure 12 and the lead frame assembly 16. As shown in FIGS. 5 and 6, optical support structure 12 is dimensioned so as to cover a portion of the code disk 18. In alternative embodiments, the optical support structure 12 can be enlarged so as to cover a larger portion of or the entirety of the code disk 18. In the alternative embodiments, the enlarged optical support structure can be dimensioned to contain the optical element 32, such as a prismatic lens. In either embodiment, the optical support structure 12 acts as a cover to protect the code disk 18 and optical element 32, and optionally the code disk 18.

The optical support structure 12 includes the support structure body 28 within which the optic 32 is located.

As shown in FIGS. 3-6, the lead frame assembly 14 includes the lead frame 34 defining both the sensor cavity 40 and the LED cavity 47. The lead flame contact 38 is disposed on the lead frame 34 within the volume defined by the cavity 40. The sensor 36 is layered directly on the lead flame contact 38. An optically transparent encapsulant 54 is deposited on the sensor 36 and substantially filling the volume defined by the cavity 40. The encapsulant 54 is used for protecting the sensor 36 and its associated electronics, including the lead frame contact 38, while allowing light (such as infrared light) from the LED 50 to pass through.

As shown in FIG. 11, the LED cavity 47, which is a portion of the lead frame 34, includes both an LED contact pad 48 and an LED bond pad 52 disposed thereon. As shown in FIG. 12, the pads 48, 52 have portions 108.1, 108.2, respectively, that extend past the lead frame 34 and function as external connector pads. The contact pad 48 has an internal portion that lies upon the lead frame 34 so as to be aligned within the volume defined by the LED cavity 47 and has the LED 50 supported thereon. The LED 50 is connected to LED bond pad 52 via a connecting wire 57.

FIG. 7 is a partial cross-section of the positional encoder assembly 10 taken along section 7-7 of FIG. 5. As previously described, the lead frame assembly 14 is directly disposed on the circuit board assembly 16. The lead frame contact 38 is disposed on the lead frame 34 within the volume defined by the cavity 40. The sensor 36 is layered directly on the lead frame contact 38. The optically transparent encapsulant 54 is deposited on the sensor 36 and substantially filling the volume defined by the cavity 40.

As shown in cross-section, the sensor 36 is connected to the set of external connector pads 42.1, 42.10 by a corresponding set of wire bonds 58.1, 58.10. As previously noted, the set of the external connector pads 42.1-42.10 are coupled to the circuit board assembly 16 via the set of external connectors 44.1-44.10. It is a particular advantage of the present invention that the external connectors 44.1-44.10 do not directly contact the circuit board assembly 16. Rather, the external connectors 44.1-44.10 are bonded to the circuit board assembly 16 by solder deposits 56.1-56.10. These features are more readily apparent in FIG. 8, which is an enlarged view of a portion of FIG. 7. Note that having the external connectors 44.1-44.10 and the lead frame contact 38 being supported slightly above the circuit board assembly 16 so that the cavity 40 and the lead flame 34, not the leads 54, will define the final elevation of the assembly 10.

The operation of the positional encoder assembly 10 of the present invention is improved by many design features described above. Particularly, the lead frame 34, being a rigid mechanical structure, provides an exact height of the sensor 36 above the circuit board assembly 16 which is of particular aid in the design of the encoder product.

FIG. 9(b) is a combined cross sectional view of the positional encoder of the present invention better illustrating its geometric features, but where the optical element 32 is not to scale. Of particular note is the relative elevation of the sensor 36, the external connector 44.1, and the LED 50 with respect to each other and to the circuit board assembly 16.

In a preferred embodiment shown in FIG. 9, the external connector 44.1 is disposed a distance A that is approximately 0.05-0.1 millimeters above the surface of the circuit board assembly 16.

In a preferred embodiment, the sensor 36 is disposed at a distance H above the circuit board assembly 15 that has a value that has a value that lies between 0.7 and 1.0 millimeters.

Moreover, the solder deposit 56.1 connecting the sensor 36 to the circuit board assembly 16 does not interfere with the determination of the elevation H of the sensor 36 in relation to the circuit board assembly 16.

In a preferred embodiment, the combined dimensions of the lead frame 34 and the LED contact pad 48 disposed below the LED 50 are such that the top of the combination of frame 34 and pad 48 lies at a distance F+B above the circuit board assembly 16. The distance F+B has a value between 0.8 and 2.0 millimeters.

The distance F is the distance from the top of LED contact pad 48 and the top of the lead frame contact 38 and has a value that lies between 0.3 and 1.0 millimeters, more preferably between 0.3 and 0.6 millimeters. The distance B is the distance from the top of the lead frame contact 38 to the circuit board assembly 16 and has a value of approximately 0.5 mm to 0.6 mm. In addition, the bottom of the LED bond pad 52 is positioned a distance F above the lead frame contact 38 as shown in FIGS. 9 and 10.

By positioning the LED contact pad 48 at an elevated level F with respect to the lead frame contact 38, the optical element 32 may be moved farther away from the sensor 36 for a given focal length K between the LED 50 and the optical element 32, thereby allowing for thicker materials such as glass to be used for the code disk 18. Note that for the shown embodiment, the focal length K (approximately 1.4 mm) is measured from the top of the sensor LED to the optical element 32.

Similarly, by defining a precise depth of the cavity 40 within the lead frame 34, the distance between the sensor 36 and the code disk 18 can be determined with greater precision than is possible using traditional COB dam-and-fill encapsulation techniques. For example, for a molded plastic lead frame 34, the dimensional tolerances are on the order of 50 microns, which is 2 to 5 times more accurate than can be held using dam-and-fill methods. Using precise molding techniques, the cavity 40 can be made to an optimal size which contains only the sensor 36, the wire bonds 58, and a minimal amount of encapsulant 54. Additionally, the cavity 40 eliminates the need for multiple types of encapsulation, requiring only one encapsulant 54 to cover the sensor 36 and wire bonds 58.

Placement of the set of external connector pads 42 at an elevation commensurate with the top surface of sensor 36 allows for the use of very low loop height wire bonds 58. In particular, the bonds 58 preferably rise a maximum distance D (approximately 1.1 mm) above the circuit board assembly 16. This further reduces the amount of material required to encapsulate the wire bonds 58 and sensor 36. The placement of the set of external connector pads 42 also decreases the length of the wire bonds 58, thereby increasing overall performance of the positional encoder assembly 10. Moreover, the elevated set of external connectors 42 eliminates the possibility of bonding errors caused by wire contacting the edge of the sensor 36 and resulting in a short circuit.

It is another feature of the present invention that the recesses 46 and projections 30 rigidly connect the optical support structure 12 and the lead frame assembly 14. The snap-fit design of the present invention allows a user to install the parts in a top-down fashion consistent with the practices of Design for Manufacturing and Assembly.

As described above, the present invention is an improved positional encoder assembly including in part an optical support structure and a lead frame wherein the lead frame advantageously supports and contains a sensor and its attendant electronics. Nevertheless, it is understood that the preceding description pertains only to a preferred embodiment, and that various modifications to the present invention can be made by those skilled in the art without departing from the scope of the present invention as set forth in the following claims. For example, the dimensions and shape of the lead frame can be varied so as to accommodate different sizes of sensors and to minimize the amount of encapsulation as much as possible.

We claim:

1. A positional encoder assembly comprising: a light source to generate an optical signal;
an optical support structure housing a refractive optic to direct the optical signal, the optical support structure defining a projection;
a lead frame defining a cavity, a hollow within which the light source is disposed, and at least one recess to receive the projection; and
a sensor disposed within the cavity and adapted to generate an electrical signal in response to the optical signal, the electrical signal distributed to a circuit board assembly; wherein the lead frame is disposed on the circuit board assembly such that the sensor is disposed at a predetermined elevation with respect to the circuit board assembly.

2. The positional encoder assembly of claim 1, wherein the sensor is an integrated OPTO-ASIC sensor.

3. The positional encoder assembly of claim 1, further comprising a lead frame contact disposed beneath the sensor.

4. The positional encoder assembly of claim 1, further comprising an external connector protruding from the lead frame, the external connector connectable to the circuit board assembly.

5. The positional encoder assembly of claim 4, further comprising an external connector pad coupled to the external connector.

6. The positional encoder assembly of claim 5, further comprising a wire bond connectable between the sensor and the external connector pad.

7. The positional encoder assembly of claim 1, further comprising an optically transparent encapsulant layer disposed on the sensor.

8. The positional encoder assembly of claim 7, wherein the optically transparent encapsulant layer encapsulates the sensor, the wire bond, and the external connector pad.

9. The positional encoder assembly of claim 7, wherein the optically transparent encapsulant layer is contained within the cavity of the lead frame.

10. The positional encoder assembly of claim 1, further comprising a code disk disposed between the optical support structure and the lead frame.

11. The positional encoder assembly of claim 1, wherein the refractive optic is a prismatic lens.

12. The positional encoder assembly of claim 1, wherein the predetermined elevation is between 0.7 and 1.0 millimeters.

13. The positional encoder assembly of claim 1, wherein the light source is disposed at a second predetermined elevation with respect to the circuit board assembly.

14. The positional encoder assembly of claim 1, wherein the light source is disposed at a second predetermined elevation with respect to the circuit board assembly, and further wherein the second predetermined elevation is greater than the predetermined elevation.

15. A lead frame assembly comprising:
a lead frame defining a cavity;
a lead frame contact disposed within the cavity, and
a sensor disposed on the lead frame contact.

16. The lead frame assembly of claim 15, wherein the sensor is an integrated OPTO-ASIC sensor.

17. The lead frame assembly of claim 15, further comprising an external connector protruding from the lead frame.

18. The lead frame assembly of claim 17, further comprising an external connector pad coupled to the external connector.

19. The lead frame assembly of claim 18, further comprising a wire bond connectable between the sensor and the external connector pad.

20. The lead frame assembly of claim 15, further comprising an optically transparent encapsulant layer disposed on the sensor.

21. The lead frame assembly of claim 20, wherein the optically transparent encapsulant layer encapsulates the sensor, the wire bond, and the external connector pad.

22. The lead frame assembly of claim 20, wherein the optically transparent encapsulant layer is contained within the cavity of the lead frame.

23. The lead frame assembly of claim 15, further comprising a recess in the lead frame for coupling to an optical support structure.

24. The lead frame assembly of claim 15, further comprising a cavity in the lead frame for receiving a light source.

25. The lead frame assembly of claim 24, further comprising a light source disposed within the cavity.

26. The lead frame assembly of claim 25, further comprising a contact disposed between the light source and the cavity.

27. A positional encoder assembly comprising:
a light source to generate an optical signal;
a circuit board assembly;
a lead frame supported upon the circuit board assembly, the lead frame defining a first cavity and a hollow within which the light source is disposed;
a connector positioned above the circuit board assembly and located externally to the lead frame;
a connector pad positioned within a second cavity defined by the lead frame and is electrically connected to the connector;
a sensor disposed within the second cavity supported upon a lead frame contact and adapted to generate an electrical signal in response to the optical signal, the electrical signal distributed to a wire bond that is located within the second cavity and is in electrical contact with the connector pad so that the electrical signal is distributed to the connector and the circuit board assembly; wherein the second cavity has a height that is above a maximum height of the wire bond and the connector pad is at least as high above the circuit board assembly as a top surface of the sensor.

28. The positional encoder assembly of claim 27, further comprising:
an optical support structure housing a refractive optic to direct the optical signal, the optical support structure defining a projection;
the lead frame defining at least one recess to receive the projection in a snap fit fashion.

29. The positional encoder assembly of claim 27, wherein the sensor is an integrated OPTO-ASIC sensor.

30. The positional encoder assembly of claim 27, further comprising an optically transparent encapsulant layer disposed on the sensor.

31. The positional encoder assembly of claim 30, wherein the optically transparent encapsulant layer encapsulates the sensor, the wire bond, and the connector pad.

32. The positional encoder assembly of claim 30, wherein the optically transparent encapsulant layer is contained within the second cavity of the lead frame.

33. The positional encoder assembly of claim 27, further comprising a code disk disposed between the optical support structure and the lead frame.

34. The positional encoder assembly of claim 28, wherein the refractive optic is a prismatic lens.

35. The positional encoder assembly of claim 27, wherein the light source is disposed at a second predetermined elevation with respect to the circuit board assembly, and further wherein the second predetermined elevation is greater than the first predetermined elevation.

36. The positional encoder assembly of claim 27, wherein the light source lies above the lead frame contact.

37. A positional encoder assembly comprising:
a light source to generate an optical signal;
a circuit board assembly;
a lead frame supported upon the circuit board assembly, the lead frame defining a first cavity within which the light source is disposed;
a connector positioned above the circuit board assembly and located externally to the lead frame;
a connector pad positioned within a second cavity defined by the lead frame and is electrically connected to the connector;
a sensor disposed within the second cavity supported upon a contact and adapted to generate an electrical signal in response to the optical signal, the electrical signal distributed to a wire bond that is located within the second cavity and is in electrical contact with the connector pad so that the electrical signal is distributed to the connector and the circuit board assembly; wherein the second cavity lies below the first cavity.

38. The positional encoder assembly of claim 37, further comprising:
an optical support structure housing a refractive optic to direct the optical signal, the optical support structure defining a projection;
the lead frame defining at least one recess to receive the projection in a snap fit fashion.

39. The positional encoder assembly of claim 37, wherein the sensor is an integrated OPTO-ASIC sensor.

40. The positional encoder assembly of claim 37, further comprising an optically transparent encapsulant layer disposed on the sensor.

41. The positional encoder assembly of claim 40, wherein the optically transparent encapsulant layer encapsulates the sensor, the wire bond, and the connector pad.

42. The positional encoder assembly of claim 40, wherein the optically transparent encapsulant layer is contained within the second cavity of the lead frame.

43. The positional encoder assembly of claim 37, further comprising a code disk disposed between the optical support structure and the lead frame.

44. The positional encoder assembly of claim 38, wherein the refractive optic is a prismatic lens.

45. The positional encoder assembly of claim 37, wherein the light source is disposed at a second predetermined elevation with respect to the circuit board assembly, and further wherein the second predetermined elevation is greater than the first predetermined elevation.

46. The positional encoder assembly of claim 27, wherein the light source lies above the lead frame contact.
